(19) United States
(12) Patent Application Publication
(10) Pub. No.: US 2009/0109080 A1
(43) Pub. Date: Apr. 30, 2009

(54) Remote control security supervisory control method

(75) Inventor: Cheng-Hung Huang, Taoyuan County (TW)

Correspondence Address: Joe McKinney Muncy, PO Box 1364, Fairfax, VA, 22038-1364, US

(73) Assignee: EVERSPRING INDUSTRY CO., LTD.

(21) Appl. No.: 11/979,018

(22) Filed: Oct. 30, 2007

(51) Int. Cl. H04L 17/02; G08B 29/00

(52) U.S. Cl. 341/176; 340/506

(57) ABSTRACT

A remote control security supervisory control method adopted for use on a security supervisory control system which includes at least a sensor to detect risky conditions in a surveillance scope and a system host to execute a security supervisory control system procedure. The system includes a remote control device capable of performing remote control. The method of the invention includes steps of: sending a wake-up signal from the remote control device to the sensor; the sensor received the wake-up signal entering a setting mode from a sleeping mode in regular conditions to alter the system procedure; the remote control device sending a command signal to the system host through the sensor to alter the existing security supervisory control system procedure to redo setting of the system procedure; and the system host received the command signal feeding back a confirmation signal to the sensor to finish the alteration setting.

### FIELD OF THE INVENTION

The present invention relates to a security supervisory control system control method and particularly to a control method for a security supervisory control system to control remote sensors.

### BACKGROUND OF THE INVENTION

A conventional security system for residence discloses in U.S. Pat. No. 7,113,099 and U.S. Pat. No. 5,689,235 which generally consists of a system host, various types of sensors, monitor video cameras and various types of alarms. These devices are communicated through radio frequency signals. In the past, when the system host is in an alert condition, namely people are absent from the house, commands have to be entered in advance on the keyboard of the system host to make all the sensors and alarms under the control of the system host to enter an alert condition to guard against intruders or detect risky environmental conditions. When the people of the house return or are resting indoors at night, the alarms and sensors cannot be all set ON, otherwise the sensors in the house could be mistakenly triggered to generate a faulty alarm. Hence the system host should be able to selectively actuate the sensors. While such a technique resolves the problem of triggering faulty alarm, it also creates other problems to users. Because the sensors have to be selectively actuated, all the alarms and sensors have be coded and numbered. And the individual number of the alarms and sensors have to be entered on the keyboard of the system host according to requirements so that the computer of the system host can determine which alarms and sensors to be set ON and OFF. In a smaller space in which the number of the alarms or sensors is smaller, a user can set the required sensors based on his/her memory. In the event that the scope of security alarm is greater, and the number of sensors increases. To set the required sensors not only has to rely on user's memory but also has to enter the number of the individual sensors into the system host. It is tedious and takes a lot of time. At present setting a complete security system still has to rely on the technicians of the security service provider. The service fee is charged according to the service content. Altering system procedures incurs additional expense to house owners. Alteration of the security system also cannot be done instantly according to requirement.

### SUMMARY OF THE INVENTION

The primary object of the present invention is to simplify setting of a security system and reduce setting time and cost. To achieve the foregoing object the invention provides a remote control security supervisory control method adopted for use on a security supervisory control system. The security supervisory control system includes at least a sensor to detect risky conditions in a surveillance scope and a system host to execute a security supervisory control system procedure. The security supervisory control method includes steps of: providing a remote control device controlled at a remote site to output a wake-up signal to the sensor; the sensor received the wake-up signal entering a setting mode from a sleeping mode to change system procedure; the remote control device delivering a command signal through the sensor to the system host to change the existing security supervisory control system procedure to redo setting of the system procedure; the system host received the command signal feeding back a confirmation signal to the sensor to finish alteration of the setting. In addition, after the sensor has received the wake-up signal, it transforms to a first determination signal to be selectively sent to the system host or the remote control device. The system host or remote control device feedbacks a second determination signal to determine whether the sensor to receive the command signal from the remote control device to change the system. By means of the remote control security supervisory control method of the invention users can easily set ON and OFF of the individual sensors through a remote control approach without setting on the system host for the detection scope as the conventional security system does. Hence setting of the security system is greatly simplified. It also requires only a lower technical skill and less time to do the setting.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a fundamental structure of an embodiment of the invention.

FIG. 2 is a flowchart of an embodiment of the invention.

FIG. 3 is a method block diagram of the invention to determine whether a sensor to receive a first command signal.

FIG. 4 is a flowchart to determine whether a sensor to receive the first command signal.

FIG. 5 is another method block diagram of the invention to determine whether a sensor to receive the first command signal.

FIG. 6 is another flowchart to determine whether a sensor to receive the first command signal.

### DETAILED DESCRIPTION OF THE PREFERRED EMBODIMENTS

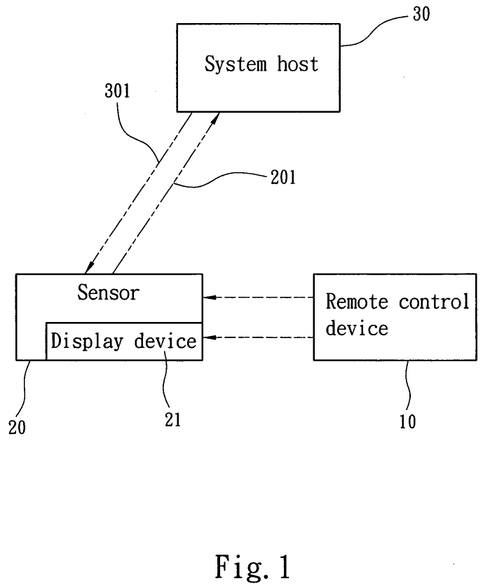

Please refer to FIG. 1, the present invention aims to provide a remote control security supervisory control method adopted for use on a security supervisory control system. The security supervisory control system includes a remote control device 10, at least one sensor 20 to detect risky conditions in a surveillance scope, and a system host 30 to execute a security supervisory control system procedure. The sensor 20 detects the risky conditions and informs the system host 30 to execute the security supervisory control system procedure. Transmission of signals in the security supervisory control system is carried out through radio frequency.

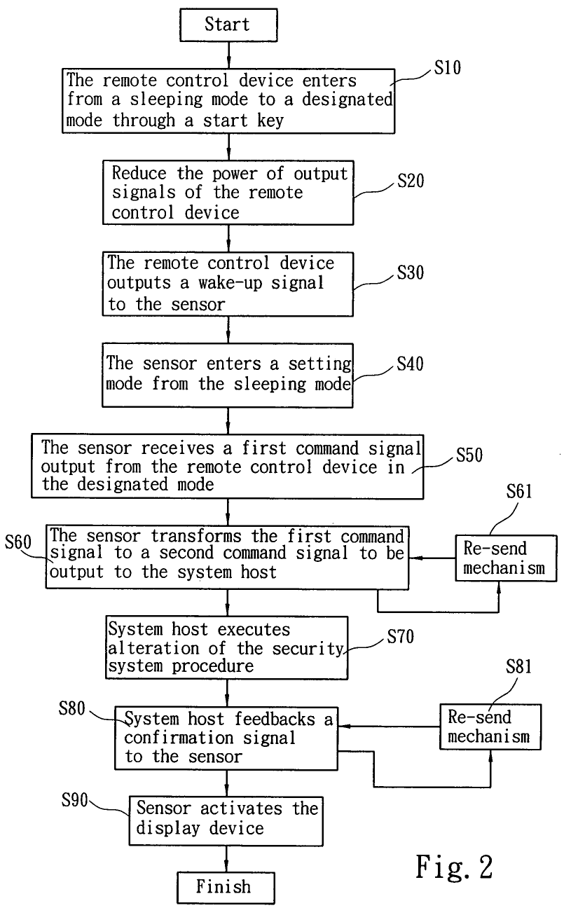

Refer to FIGS. 1 and 2 for a main flowchart of an embodiment of the invention. The remote control device 10 enters from a sleeping mode to a designated mode (step S10); in the designated mode, the remote control device 10 reduces the power of output signals (step S20) so that the remote control device 10 can reduce power output of a first wake-up signal 111 and a first command signal 121 according to each sensor 20 to prevent neighboring sensors 20 from receiving the signal from the same remote control device 10 and incurring interference of the output commands; In the designated mode the remote control device 10 first sends the wake-up signal 111 to the sensor 20 (step S30), and the sensor 20 determines whether to enter the setting mode from the sleeping mode according to the intensity of the wake-up signal 111; in the event that the intensity of the wake-up signal 111 is greater than a set power the sensor 20 enters the setting mode, otherwise it remains in the sleeping mode; when the sensor 20 enters the setting mode from the sleeping mode (step S40), the sensor 20 can receive the first signal 121 of the lower power output from the remote control device 10 in the designated mode (step S50), and the sensor 20 transforms the first command signal 121 to a second command signal 201 which is sent to the system host 30 (step S60); upon receiving the second command signal 201, the system host 30 executes alteration of the security supervisory control system procedure (step S70); the alteration of the security supervisory control system procedure may be ON/OFF of alert function of the sensor 20, or setting of clusters of a plurality of the sensors 20; after the change is finished, the system host 30 feedbacks a confirmation signal 301 to the sensor 20 (step S80); the sensor 20 received the confirmation signal 301 actuates a display device 21 (step S90) to inform users that setting alteration is finished. In the event that the second command signal 201 output from the sensor 20 or the confirmation signal output from the system host 30 is lost during transmission, a resend mechanism is provided to make sure that signal output is delivered correctly without missing (steps S61 and S81).

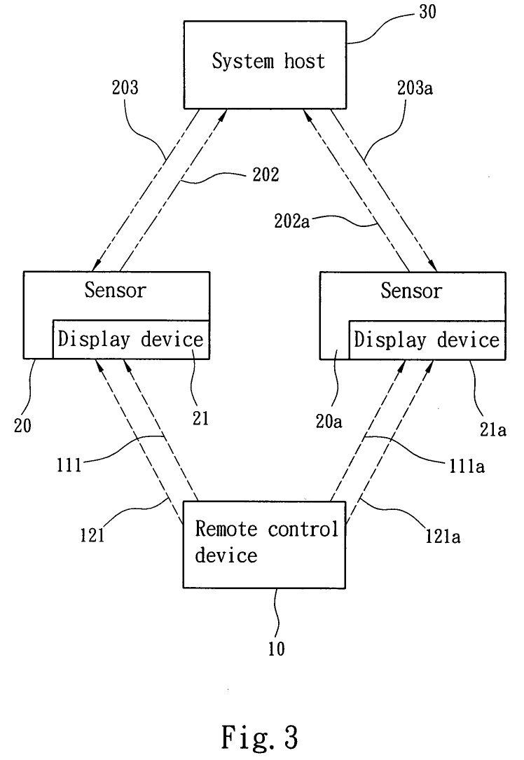

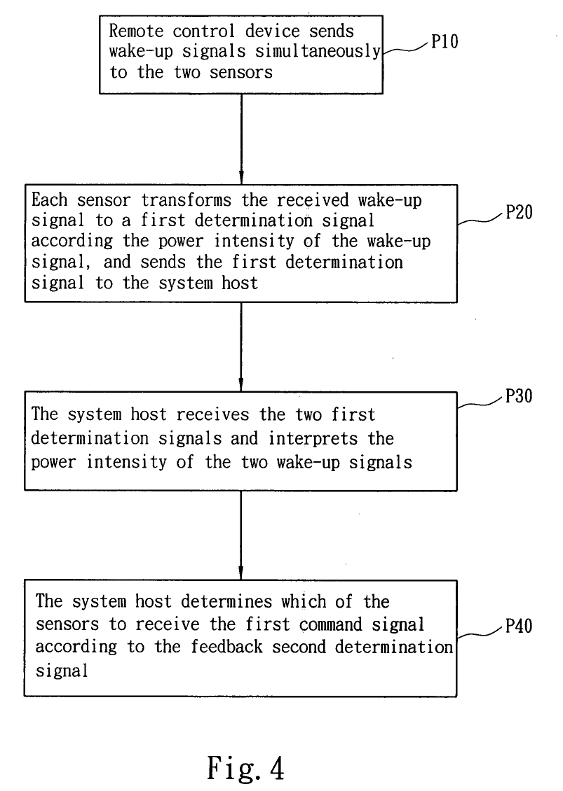

In order to prevent the sensors 20 from erroneously entering the setting mode by a signal of a lower power caused by the remote control device 10 due to their being too close to one another, the invention provides two measures to determine which sensor 20 to receive the first command signal 121 from the remote control device 10 thereby to alter the security supervisory control system procedure. Refer to FIGS. 3 and 4 for a block diagram and a flowchart for determining whether a sensor is to receive the first command signal. Two neighboring sensors 20 and 20a are provided as an example. The remote control device 10 transmits wake-up signals 111 and 111a simultaneously to the two sensors 20 and 20a (step P10); the sensors 20 and 20a, depending on the power intensity of the wake-up signals 111 and 111a, transform respectively to a first determination signal 202 and 202a to be sent to the system host 30 (step P20); the system host 30 receives the first determination signals 202 and 202a, and interprets the power intensity of the two wake-up signals 111 and 111a (step P30), then determines which of the sensors 20 and 20a to receive the first command signal 121 and 121a. Finally, according to second determination signals 203 and 203a from the sensors 20 and 20a (step P40) whether the sensors 20 and 20a to receive the follow on signals from the remote control device 10 is determined. If it is judged that one sensor 20 is closer to the remote control device 10, that sensor 20 receives the first command signal 121; while the other sensor 20a that is being judged farther away from remoter control device 10 does not receive the other first command signal 121a.

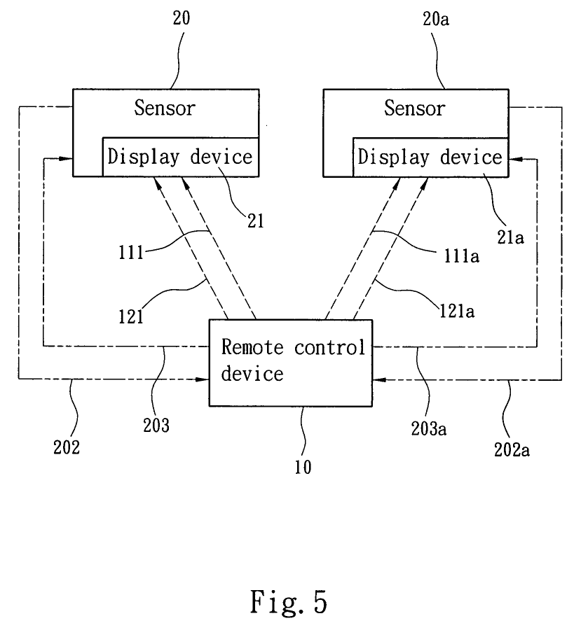

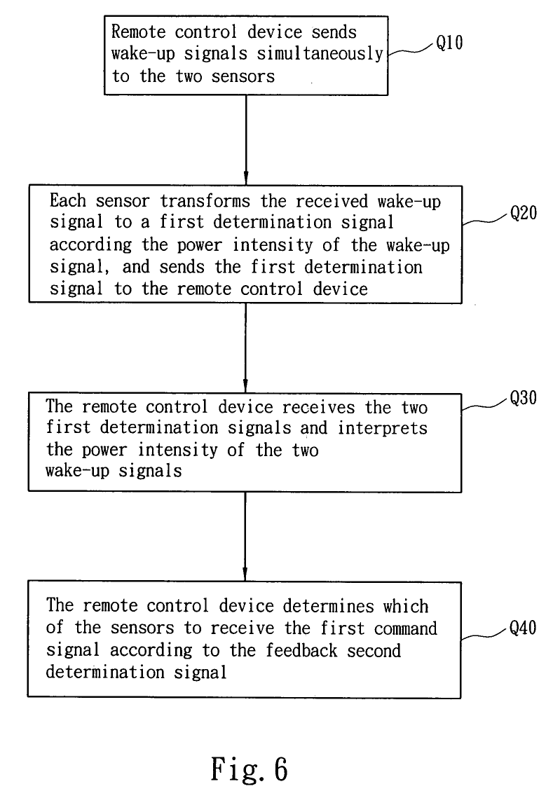

Refer to FIGS. 5 and 6 for another method block diagram and another flowchart for determining whether a sensor is to receive the first command signal. Two sensors 20 and 20a are used as an example. The remote control device 10 sends the wake-up signals 111 and 111a simultaneously to the two sensors 20 and 20a (step Q10); the sensors 20 and 20a, depending on the power intensity of the wake-up signals 111 and 111a, transform respectively to the first determination signals 202 and 202a to be sent to the remote control device 10 (step Q20); the remote control device 10 receives the first determination signals 202 and 202a, and interprets the power intensity (step Q30) and determines which of the sensors 20 and 20a to receive the first command signal 121 and 121a. Finally, according to second determination signals 203 and 203a from the sensors 20 and 20a (step Q40) whether the sensors 20 and 20a to receive the follow on signals from the remote control device 10 is determined.

The remote control security supervisory control method of the invention controls the sensor 20 through the remote control device 10. It simplifies the alteration procedure of the conventional security supervisory control system that has to be performed on the system host 30. The remote control device 10 can directly set ON/OFF of alarm function of the individual sensor 20 or set clusters of sensors 20. Thus time and effort for setting the sensor 20 can be reduced. The setting procedure of the sensor 20 is simpler. And users can perform setting immediately according to requirements.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A remote control security supervisory control method to be used on a security supervisory control system which has at least one sensor to detect risky conditions in a surveillance scope and a system host to execute a security supervisory control system procedure, the method comprising the steps of:
providing a remote control device which reduces signal power output from the remote control device during remote control;
sending a wake-up signal from the remote control device to the sensor;
entering a setting mode from a sleeping mode in regular conditions after the sensor having received the wake-up signal to alter the system procedure;
sending a command signal from the remote control device to the system host through the sensor to alter an existing security supervisory control system procedure and redo setting of the system procedure; and
feeding back a confirmation signal by the system host after having received the command signal to the sensor to finish the alteration setting.

2. The remote control security supervisory control method of claim 1, wherein the wake-up signal is transformed to a first determination signal through the sensor that is sent to the system host which interprets and feedbacks a second determination signal to determine whether the sensor is to receive the command signal of the remote control device.

3. The remote control security supervisory control method of claim 1, wherein the wake-up signal is transformed to a first determination signal through the sensor that is sent to the remote control device which interprets and feedbacks a second determination signal to determine whether the sensor is to receive the command signal of the remote control device.

4. The remote control security supervisory control method of claim 1, wherein the alteration of the security system procedure includes regulation of ON/OFF of an alert function of the sensor.

5. The remote control security supervisory control method of claim 1, wherein the alteration of the security supervisory control system procedure includes setting a plurality of sensor clusters.
